(19) United States
(12) Patent Application Publication
(10) Pub. No.: US 2026/0280959 A1
(43) Pub. Date: Sep. 17, 2026

(54) MACHINE LEARNING-BASED CONSTELLATION SHAPING IN WIRELESS COMMUNICATION NETWORK

(71) Applicant: Nokia Solutions and Networks Oy, Espoo (FI)

(72) Inventors: Selahattin GOKCELI, Espoo (FI); Sahan Damith LIYANAARACHCHI, Tampere (FI); Dani Johannes KORPI, Espoo (FI)

(21) Appl. No.: 19/474,427

(22) PCT Filed: Apr. 13, 2023
(86) PCT No.: PCT/EP2023/059616

§ 371 Date: Oct. 10, 2025

(51) Int. Cl. H04L 27/36; H04L 27/26

(52) U.S. Cl. CPC H04L 27/368; H04L 27/2618; H04L 27/2636; H04L 27/26524

(57) ABSTRACT

A technical solution is provided, which enables low-Peak-to-Average Power Ratio (PAPR) waveform design by using Machine Learning (ML)-based constellation shaping in a wireless communication network. Original bits are processed by an autoencoder comprising an encoder and a decoder. The encoder obtains a vector of data symbols by mapping the original bits to a constellation diagram and transmits it to the decoder while applying a random Power Amplifier (PA) model. The decoder obtains restored bits by decoding the received vector of data symbols in accordance with a detection algorithm. Further, a loss function value is calculated based on the original and restored bits. The autoencoder is then trained by jointly correcting the constellation diagram and the detection algorithm based on the loss function value. The processing, calculation and training steps are repeated by using the corrected constellation diagram and detection algorithm until a target training condition is met.

### TECHNICAL FIELD

The present disclosure relates generally to the field of wireless communication. In particular, the present disclosure relates to an apparatus and method for performing Machine Learning (ML)-based constellation shaping in a wireless communication network.

### BACKGROUND

A low Power Amplifier (PA) efficiency on a transmitting side is one of crucial problems in high-frequency (e.g., sub-THz) communications. Additionally, a phase noise also degrades a transmission quality significantly at high frequencies. A Cyclic Prefix Orthogonal Frequency Division Multiplex (CP-OFDM) waveform, which is the main waveform of a physical layer in a fifth generation (5G) New Radio (NR) system, is not an efficient option for the high-frequency communications as it has a quite high Peak-to-Average Power Ratio (PAPR), which harms the PA efficiency significantly.

Unlike the CP-OFDM waveform, a Discrete Fourier Transform spread OFDM (DFT-s-OFDM) waveform is a good candidate for the high-frequency (e.g., sub-THz) communications due to its PAPR being lower than that of the CP-OFDM waveform. Furthermore, the DFT-s-OFDM waveform is proved to perform better than the CP-OFDM waveform under the phase noise. Due to such advantages, the DFT-s-OFDM waveform can be expected to be one of the main waveforms for the high-frequency communications in next-generation (e.g., sixth generation (6G)) communication systems.

However, the PAPR performance of the conventional DFT-s-OFDM waveform relies on the modulation used and it cannot offer the same PAPR advantage when high-order modulations are utilized, such as 64-Quadrature Amplitude Modulation (QAM) and 256-QAM. This can be considered as an important drawback for the DFT-s-OFDM waveform's potential in the next-generation communication systems where higher-order modulations are expected to be preferred more to increase a data rate. Therefore, there is a clear need to provide a PAPR-improved waveform especially for the higher-order modulation scenarios.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables efficient (in terms of the PAPR) waveform design by using ML-based constellation shaping in a wireless communication network.

The objective above is achieved by the features of the independent claims in the appended claims. Further embodiments and examples are apparent from the dependent claims, the detailed description, and the accompanying drawings.

According to a first aspect, an apparatus for performing ML-based constellation shaping in a wireless communication network is provided. The apparatus comprises at least one processor and at least one memory storing instructions that, when executed by the at least one processor, cause the at least one processor to perform at least as follows. At first, the at least one processor obtains an original set of bits. Then, the at least one processor processes the original set of bits by using an autoencoder comprising an encoder and a decoder. The encoder is configured to encode the original set of bits into a vector of data symbols by mapping the original set of bits to a constellation diagram corresponding to a modulation scheme of interest, as well as transmit the vector of data symbols to the decoder while applying a random Power Amplifier (PA) model to the vector of data symbols. The decoder is configured to receive the vector of data symbols and obtain a restored set of bits by decoding the received vector of data symbols in accordance with a detection algorithm. Next, the at least one processor calculates a value of a loss function based on the original set of bits and the restored set of bits. Further, the at least one processor trains the autoencoder by jointly correcting the constellation diagram and the detection algorithm based on the value of the loss function. After that, the at least one processor repeats the above-indicated processing, calculation and training operations by using the corrected constellation diagram and the corrected detection algorithm until a target training condition is met. The apparatus thus configured may provide efficient end-to-end training of a wireless communication system by regarding the transmitter and receiver of the system as the encoder and decoder of the autoencoder, respectively. By jointly optimizing the constellation diagram and the detection algorithm during the training of the autoencoder, it is possible to improve the transmission performance of the wireless communication system, since the learned wireless communication system will be compatible with various impairments, such as PA nonlinearities and channel impairments. Hence, Bit-Error Rates (BERs) experienced by the receiver in the wireless communication system may be minimized, and PAPR and Adjacent Channel Leakage Ratio (ACLR) metrics may be improved, thereby making the wireless communication system more energy-efficient.

In one example embodiment of the first aspect, the encoder of the autoencoder is configured to transmit the vector of data symbol by using an OFDM waveform. This means that the apparatus according to the first aspect may be applicable in the communication scenarios which involve using OFDM signals.

In one example embodiment of the first aspect, the OFDM waveform comprises a DFT-s-OFDM waveform or a CP-OFDM waveform. Due to the above-described joint optimization of the constellation diagram and the detection algorithm during the training of the autoencoder, the apparatus according to the first aspect may efficiently (in terms of PAPR) adapt the conventional DFT-s-OFDM and CP-OFDM waveforms for different modulation scenarios, including those in which the modulation order is higher than 4.

In one example embodiment of the first aspect, the encoder of the autoencoder is further configured, before transmitting the vector of data symbols, to apply a PAPR reduction mechanism to the vector of data symbols. By using the PAPR reduction mechanism, it is possible to additionally improve the PAPR and ACLR metrics.

In one example embodiment of the first aspect, the at least one processor trains the autoencoder by jointly correcting the constellation diagram, the detection algorithm and the PAPR reduction mechanism based on the value of the loss function. By optimizing the PAPR reduction mechanism jointly with the constellation diagram and the detection algorithm during the training of the autoencoder, it is possible to provide the generation of proper peak-cancellation signals and consequently improve the PAPR metric even more. This allows better end-to-end training of the wireless communication system with overall better performance gains but at the cost of higher training complexity.

In one example embodiment, the loss function comprises a sum of three terms, where a first term is associated with a binary cross-entropy between the original set of bits and the restored set of bits, a second term is associated with an ACLR after the PA model is applied to the vector of data symbols, and a third term is associated with a minimum distance between points of the constellation diagram. By using this loss function, it is possible to optimize the constellation diagram and the detection algorithm more efficiently, thereby enabling lower-PAPR waveform design. If the PAPR reduction mechanism is used, the detection algorithm (or, in other words, the receiver) may be adapted to handle the extra distortion caused by the separate PAPR reduction mechanism.

In one example embodiment of the first aspect, the target training condition is based on a Stochastic Gradient Descent (SGD) algorithm (e.g., ADAM optimizer). By using this training condition, it is possible to train the autoencoder more efficiently.

According to a second aspect, a method for performing ML-based constellation shaping in a wireless communication network is provided. The method starts with the step of obtaining an original set of bits. Then, the method proceeds to the step of processing the original set of bits by using an autoencoder comprising an encoder and a decoder. The encoder is configured to encode the original set of bits into a vector of data symbols by mapping the original set of bits to a constellation diagram corresponding to a modulation scheme of interest, as well as transmit the vector of data symbols to the decoder while applying a random PA model to the vector of data symbols. The decoder is configured to receive the vector of data symbols and obtain a restored set of bits by decoding the received vector of data symbols in accordance with a detection algorithm. Next, the method goes on to the step of calculating a value of a loss function based on the original set of bits and the restored set of bits. Further, the method proceeds to the step of training the autoencoder by jointly correcting the constellation diagram and the detection algorithm based on the value of the loss function. The above-indicated processing, calculation and training steps are repeated by using the corrected constellation diagram and the corrected detection algorithm until a target training condition is met. By doing so, it is possible to provide efficient end-to-end training of a wireless communication system by regarding the transmitter and receiver of the system as the encoder and decoder of the autoencoder, respectively. By jointly optimizing the constellation diagram and the detection algorithm during the training of the autoencoder, it is possible to improve the transmission performance of the wireless communication system, since the learned wireless communication system will be compatible with various impairments, such as PA nonlinearities and channel impairments. Hence, Bit-Error Rates (BERs) experienced by the receiver in the wireless communication system may be minimized, and the PAPR and Adjacent Channel Leakage Ratio (ACLR) metrics may be improved, thereby making the wireless communication system more energy-efficient.

In one example embodiment of the second aspect, the encoder of the autoencoder is configured to transmit the vector of data symbol by using an OFDM waveform. This means that the method according to the second aspect may be applicable in the communication scenarios which involve using OFDM signals.

In one example embodiment of the second aspect, the OFDM waveform comprises a DFT-s-OFDM waveform or a CP-OFDM waveform. Due to the above-described joint optimization of the constellation diagram and the detection algorithm during the training of the autoencoder, the method according to the second aspect may efficiently (in terms of PAPR) adapt the conventional DFT-s-OFDM and CP-OFDM waveforms for different modulation scenarios, including those in which the modulation order is higher than 4.

In one example embodiment of the second aspect, the encoder of the autoencoder is further configured, before transmitting the vector of data symbols, to apply a PAPR reduction mechanism to the vector of data symbols. By using the PAPR reduction mechanism, it is possible to additionally improve the PAPR and ACLR metrics.

In one example embodiment of the second aspect, the PAPR reduction mechanism is corrected, during the training step, jointly with the constellation diagram and the detection algorithm based on the value of the loss function. By optimizing the PAPR reduction mechanism jointly with the constellation diagram and the detection algorithm during the training of the autoencoder, it is possible to provide the generation of proper peak-cancellation signals and consequently improve the PAPR metric even more. This allows better end-to-end training of the wireless communication system with overall better performance gains but at the cost of higher training complexity.

In one example embodiment of the second aspect, the loss function comprises a sum of three terms, where a first term is associated with a binary cross-entropy between the original set of bits and the restored set of bits, a second term is associated with an ACLR level after the PA model is applied to the vector of data symbols, and a third term is associated with a minimum distance between points of the constellation diagram. By using this loss function, it is possible to optimize the constellation diagram and the detection algorithm more efficiently, thereby enabling lower-PAPR waveform design. If the PAPR reduction mechanism is used, the detection algorithm (or, in other words, the receiver) may be adapted to handle the extra distortion caused by the separate PAPR reduction mechanism.

In one example embodiment of the second aspect, the target training condition is based on an SGD algorithm (e.g., ADAM optimizer). By using this training condition, it is possible to train the autoencoder more efficiently.

According to a third aspect, a computer program product is provided. The computer program product comprises a computer-readable storage medium that stores a computer code. Being executed by at least one processor, the computer code causes the at least one processor to perform the method according to the second aspect. By using such a computer program product, it is possible to simplify the implementation of the method according to the second aspect in any computing device, like the apparatus according to the first aspect.

According to a fourth aspect, an apparatus for performing ML-based constellation shaping in a wireless communication network is provided. The apparatus comprises one or more means for performing the following operations:
(a) obtaining an original set of bits;
(b) processing the original set of bits by using an autoencoder comprising an encoder and a decoder, wherein the encoder is configured to encode the original set of bits into a vector of data symbols by mapping the original set of bits to a constellation diagram corresponding to a modulation scheme of interest and transmit the vector of data symbols to the decoder while applying a random PA model to the vector of data symbols, and wherein the decoder is configured to receive the vector of data symbols and obtain a restored set of bits by decoding the received vector of data symbols in accordance with a detection algorithm;
(c) calculating a value of a loss function based on the original set of bits and the restored set of bits;
(e) training the autoencoder by jointly correcting the constellation diagram and the detection algorithm based on the value of the loss function; and
(f) repeating operations (b)-(e) by using the corrected constellation diagram and the corrected detection algorithm until a target training condition is met.

The apparatus thus configured may provide efficient end-to-end training of a wireless communication system by regarding the transmitter and receiver of the system as the encoder and decoder of the autoencoder, respectively. By jointly optimizing the constellation diagram and the detection algorithm during the training of the autoencoder, it is possible to improve the transmission performance of the wireless communication system, since the learned wireless communication system will be compatible with various impairments, such as PA nonlinearities and channel impairments. Hence, the BERs experienced by the receiver in the wireless communication system may be minimized, and the PAPR and ACLR metrics may be improved, thereby making the wireless communication system more energy-efficient. Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a Power Amplifier (PA) output back-off for Orthogonal Frequency Division Multiplex (OFDM) and Single-Carrier Frequency-Division Multiple Access (SC-FDMA) waveforms, when assuming 20 dB Adjacent Channel Leakage Ratio (ACLR) requirement and modulation-specific error vector magnitude (EVM) requirement;

FIG. 2 shows a block diagram of an apparatus for performing machine learning (ML)-based constellation shaping in a wireless communication network in accordance with one example embodiment;

FIG. 3 shows a flowchart of a method for operating the apparatus of FIG. 2 in accordance with one example embodiment;

FIG. 4 shows a block diagram of an autoencoder used in the apparatus of FIG. 2 in accordance with one example embodiment;

FIG. 5 shows a neural network-based architecture that may be used for the autoencoder in accordance with one example embodiment;

FIG. 6 shows uncoded Bit-Error Rate (BER) results obtained by using the method of FIG. 3 and two baseline methods without ML-based constellation shaping;

FIG. 7 shows a learned constellation diagram versus a regular 256-QAM constellation diagram; and

FIG. 8 shows PAPR results obtained for a DFT-s-OFDM waveform by using the original 256-QAM constellation diagram and the learned constellation diagram.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

According to the example embodiments disclosed herein, a User Equipment (UE) may refer to an electronic computing device that is configured to perform wireless communications. The UE may be implemented as a mobile station, a mobile terminal, a mobile subscriber unit, a mobile phone, a cellular phone, a smart phone, a cordless phone, a personal digital assistant (PDA), a wireless communication device, a desktop computer, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the UE may refer to at least two collocated and inter-connected UEs thus defined.

As used in the example embodiments disclosed herein, a network node may refer to a fixed point of communication/communication node for a UE in a particular wireless communication network. More specifically, the network node may be used to connect the UE to a Data Network (DN) through a Core Network (CN) and may be referred to as a base transceiver station (BTS) in terms of the 2G communication technology, a NodeB in terms of the 3G communication technology, an evolved NodeB (eNodeB or eNB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (e.g., at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (e.g., a home). Correspondingly, the network node serving the macrocell may be referred to as a macro node, the network node serving the microcell may be referred to as a micro node, and so on.

According to the example embodiments disclosed herein, a wireless communication network, in which UEs and network nodes communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

High carrier frequencies are quite important for next-generation wireless communication networks, considering the resource scarcity issue and the benefits that these frequency ranges offer (e.g., higher capacity and data rates). The current 3rd Generation Partnership Project (3GPP) standardization supports carrier frequencies up to 52.6 GHz, which is defined in the 5G New Radio (NR) Release 15. Frequencies above this level are also studied and it is expected that they will also be integral part of future 6G specifications. Some possible mm-wave bands that could be introduced for 5G and beyond are 70/80/92-114 GHZ. More specifically, THz-frequency bands are expected to play a key role in future 6G systems due to a huge increase in an available spectrum and associated benefits.

However, some of the potential problems of such high frequencies are higher path loss and hardware problems related to Radio Frequency (RF) components, such as Power Amplifiers (PAS). Hence, a higher PA efficiency and transmission power are key for reliable performance.

Apart from Multi-Carrier (MC) waveforms such as a Cyclic Prefix Orthogonal Frequency Division Multiplex (CP-OFDM), a Single-Carrier (SC) waveform like a Discrete Fourier Transform spread OFDM (DFT-s-OFDM) waveform is also a good candidate for sub-THz communications due to its Peak-to-Average Power Ratio (PAPR) being lower than that of the CP-OFDM waveform. Also, it is found that the DFT-s-OFDM waveform performs better than the CP-OFDM waveform under a phase noise. Due to such advantages, it is seen as the main waveform for high-frequency communications.

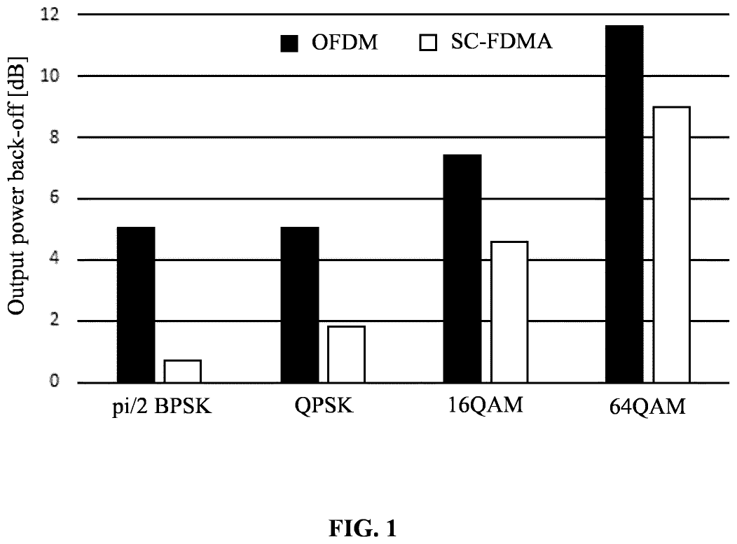

FIG. 1 shows a PA output back-off for OFDM and SC Frequency-Division Multiple Access (SC-FDMA) waveforms, when assuming 20 dB Adjacent Channel Leakage Ratio (ACLR) requirement and modulation-specific error vector magnitude (EVM) requirement. It should be noted that the DFT-s-OFDM and SC-FDMA waveforms shown in FIG. 1 have the same PAPR characteristics, for which reason one can consider the SC-FDMA waveform as the DFT-s-OFDM waveform in the PAPR case. It can be observed that the DFT-s-OFDM waveform has some significant advantages over the CP-OFDM waveform when lower-order modulations are used. However, when it comes to higher-order modulations, the advantages start to disappear and the PAPR limits the performance of the DFT-s-OFDM waveform. This is quite problematic as the higher-order modulations are expected to be used in 5G and next-generation systems more frequently. Therefore, it is essential to improve the PAPR performance of the DFT-s-OFDM waveform with the higher-order modulations to make it suitable for the high-frequency communications.

To support the above statements, Maximum Power Reduction (MPR) values in Frequency Range 1 (FR1) for a UE are indicated in Table 1 below (which per se reproduces the MPR Table from TS 38.101-1). The MPR indicates a transmit power backoff needed to support a required modulation. The values shown in Table 1 are determined by considering the requirements of ACLR, EVM and Spectral Emissions Mask (SEM), so that maximum levels that satisfy all these requirements are given. Increasing a modulation order leads to higher MPR values, and therefore reduces a UE coverage. For example, when the DFT-s-OFDM waveform is considered, the MPR is close to 0 for pi/2-Binary Phase Shift Keying (BPSK), but it increases up to 2.5 dB for 64-Quadrature Amplitude Modulation (QAM). Hence, as stated, it is crucial to improve the PAPR performance of the DFT-s-OFDM waveform to maximize the transmission power levels at the PA output.

TABLE 1
MPR values for power class 3, considering FR1 and a UE device.

| | | MPR (dB) | | |
|---|---|---|---|---|
| | | Edge RB | Outer RB | Inner RB |
| Modulation | | allocations | allocations | allocations |
| DFT-S-OFDM | Pi/2 BPSK | ≤3.5¹ | ≤1.2¹ | ≤0.2¹ |
| | | ≤0.5² | ≤0.5² | 0² |

| | QPSK | ≤1 | 0 |
|---|---|---|---|
| | 16 QAM | ≤2 | ≤1 |
| | 64 QAM | ≤2.5 | |
| | 256 QAM | ≤4.5 | |
| CP-OFDM | QPSK | ≤3 | ≤1.5 |
| | 16 QAM | ≤3 | ≤2 |

| | |
|---|---|
| 64 QAM | ≤3.5 |
| 256 QAM | ≤6.5 |

NOTE 1:
Applicable for UE operating in TDD mode with Pi/2 BPSK modulation and UE indicates support for UE capability powerBoosting-pi28PSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for UE operating in FDD mode, or in TDD mode in bands other than n40, n41, n77, n78 and n79 with Pi/2 BPSK modulation and if the IE powerBoostPi2BPSK is set to 0 and if more than 40% of slots in radio frame are used for UL transmission for bands n40, n41, n77, n78 and n79.

Additionally, there are many recent studies showing the potential advantages of Artificial Intelligence (AI)/Machine Learning (ML) especially for a physical layer comprising electronic circuit transmission technologies of a wireless communication network. It is expected that next-generation waveform design will be based on AI/ML models. In line with these requirements, new AI/ML-assisted waveforms (e.g., AI/ML-adapted DFT-s-OFDM waveforms) are quite important especially for high-frequency communications to realize the potential benefits by solving issues, such as a PA efficiency problem.

The example embodiments disclosed herein relate to a technical solution that enables efficient (in terms of the PAPR) waveform design by using ML-based constellation shaping in a wireless communication network. For this purpose, an original set of bits is processed by an autoencoder comprising an encoder and a decoder. The encoder is configured to obtain a vector of data symbols by mapping the original set of bits to a constellation diagram corresponding to a modulation scheme of interest and transmit the vector of data symbols to the decoder while applying a random PA model to the vector of data symbols. The decoder is configured to receive the vector of data symbols and obtain a restored set of bits by decoding the received vector of data symbols in accordance with a detection algorithm. Further, a value of a loss function is calculated based on the original set of bits and the restored set of bits. The autoencoder is then trained by jointly correcting the constellation diagram and the detection algorithm based on the value of the loss function. After that, the above-indicated processing, calculation and training steps are repeated by using the corrected constellation diagram and the corrected detection algorithm until a target training condition is met.

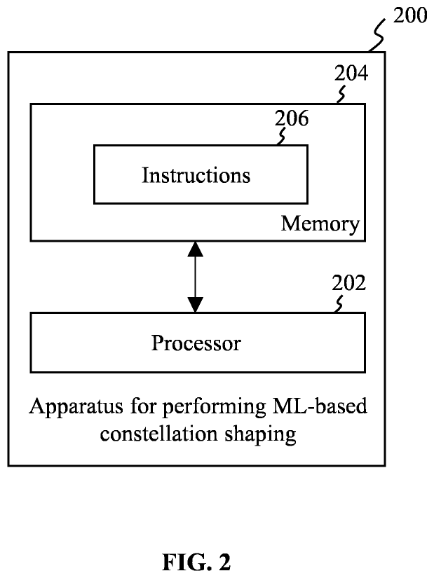

FIG. 2 shows a block diagram of an apparatus 200 for performing ML-based constellation shaping in a wireless communication network in accordance with one example embodiment. The apparatus 200 may be implemented as an individual device or be part of a UE or a network node in the wireless communication network. As shown in FIG. 2, the apparatus 200 comprises a processor 202 and a memory 204. The memory 204 stores processor-executable instructions 206 which, when executed by the processor 202, cause the processor 202 to perform the aspects of the present disclosure, as will be described below in more detail. It should be noted that the number, arrangement, and interconnection of the constructive elements constituting the apparatus 200, which are shown in FIG. 2, are not intended to be any limitation of the present disclosure, but merely used to provide a general idea of how the constructive elements may be implemented within the apparatus 200. For example, the processor 202 may be replaced with several processors, as well as the memory 204 may be replaced with several removable and/or fixed storage devices, depending on particular applications. Furthermore, in some embodiments, the processor 202 may perform different operations required to perform data reception and transmission, such, for example, as signal modulation/demodulation, encoding/decoding, etc.

The processor 202 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 202 may be implemented as any combination of one or more of the aforesaid. As an example, the processor 202 may be a combination of two or more microprocessors.

The memory 204 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 206 stored in the memory 204 may be configured as a computer-executable program code which causes the processor 202 to perform the aspects of the present disclosure. The computer-executable program code for carrying out operations or steps for the aspects of the present disclosure may be written in any combination of one or more programming languages, such as Java, C++, or the like. In some examples, the computer-executable program code may be in the form of a high-level language or in a pre-compiled form and be generated by an interpreter (also pre-stored in the memory 204) on the fly.

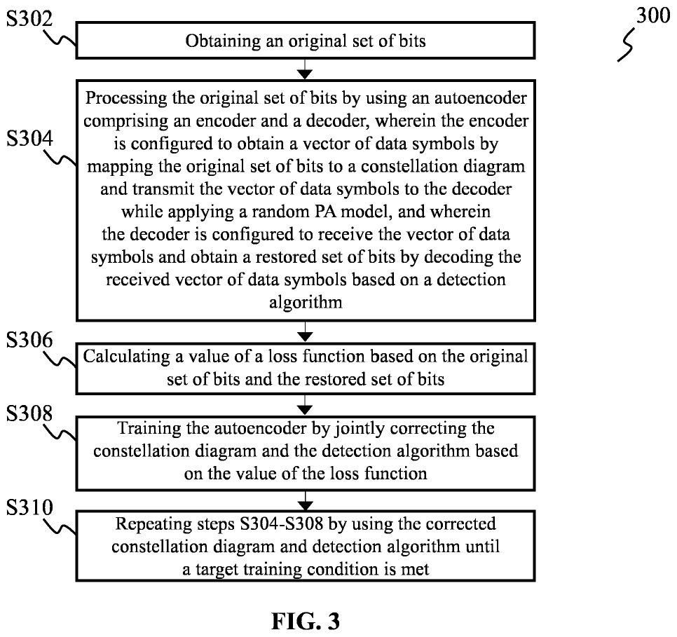

FIG. 3 shows a flowchart of a method 300 for performing ML-based constellation shaping in a wireless communication network in accordance with one example embodiment. In general, the method 300 describes the operation of the apparatus 200, and each of its steps is intended to be executed by the processor 202 of the apparatus 200.

The method 300 starts with a step S302, in which the processor 202 obtains an original set of bits. The processor 202 may either generate the original set of bits by itself or receive it from a remote device, such as a network node or a UE, for example.

Then, the method 300 proceeds to a step S304, in which the original set of bits is processed by using an autoencoder comprising an encoder and a decoder. It should be known to those skilled in the art that, in case of an end-to-end data reconstruction task, the entire physical layer “transmitter-channel-receiver” in a communication system can be regarded as an autoencoder in which an encoder plays the role of the transmitter, while a decoder plays the role of the receiver. In particular, the encoder learns to encode input data into a signal for channel transmission, while the decoder learns to restore or reconstruct the input data according to the received signal. By comparing the input data and the restored data, the parameters of the autoencoder are trained end-to-end in a supervised learning manner. Given this, the elements of the physical layer in the transmission system may be integrated into one and optimized together in a computing device (like the apparatus 200), and a better overall transmission performance may be obtained.

As for the autoencoder used in the method 300, the encoder is configured to encode the original set of bits into a vector of data symbols by mapping the original set of bits to a constellation diagram corresponding to a modulation scheme of interest, as well as transmit the vector of data symbols to the decoder while applying a random PA model to the vector of data symbols. The decoder is configured to receive the vector of data symbols and obtain a restored set of bits by decoding the received vector of data symbols in accordance with a detection algorithm. The modulation scheme of interest may be represented by QAM, Phase Shift Keying (PSK), etc. Moreover, the modulation scheme of interest may have a modulation order higher than 4, i.e., may be a high-order modulation, such as 16-QAM, 64-QAM, 256-QAM, 16-PSK, 64-PSK, 256-PSK, etc. Furthermore, the encoder may transmit the vector of data symbol by using an OFDM (e.g., DFT-s-OFDM or CP-OFDM) waveform. For example, the OFDM waveform may be used at a sub-THz frequency. One embodiment is also possible, in which the encoder may apply a PAPR reduction mechanism to the vector of data symbols before it is transmitted to the decoder. The PAPR reduction mechanism consists in generating peak-cancellation signals based on detected peaks in the vector of data symbols and an allowed level of degradation in the EVM. Some examples of the PAPR reductions mechanism include Tone Reservation (TR), Selective Mapping (SLM), clipping and filtering, Partial Transmit Sequence (PTS), etc.

After the restored set of bits is obtained, the method 300 goes on to a step S306, in which the processor 202 calculates a value of a loss function based on the original set of bits and the restored set of bits. In one embodiment, the loss function may comprise a sum of three terms, among which a first term is associated with a binary cross-entropy between the original set of bits and the restored set of bits, a second term is associated with an ACLR after the PA model is applied to the vector of data symbols, and a third term is associated with a minimum distance between points of the constellation diagram.

Further, the method 300 proceeds to a step S308, in which the processor 202 trains the autoencoder by jointly correcting the constellation diagram and the detection algorithm based on the value of the loss function. If the PAPR reduction mechanism is used by the encoder in the step S304, the PAPR reduction mechanism may be also corrected jointly with the constellation diagram and the detection algorithm based on the value of the loss function in the step S308. It should be noted that the terms “training” and “learning” (and their derivatives) are used herein interchangeably.

The method 300 ends up with a step S310, in which the processor 202 repeats the steps S304-S308 by using the corrected constellation diagram and the corrected detection algorithm until a target training condition is met. Preferably, the training condition is based on a Stochastic Gradient Descent (SGD) algorithm, such as an ADAM optimizer.

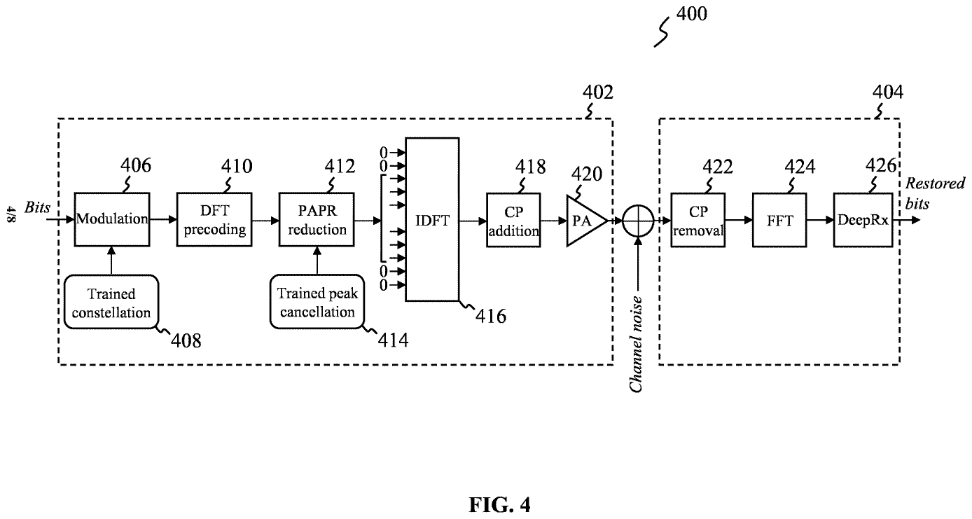

FIG. 4 shows a block diagram of an autoencoder 400 that may be used in the apparatus 200 in accordance with one example embodiment. The autoencoder 400 comprises an encoder (i.e., transmitter) 402 and a decoder (i.e., receiver) 404. Both the encoder 402 and the decoder 404 may be implemented by using a neural network (e.g., convolutional neural network, residual neural network, etc.). The encoder 402 comprises a modulation block 406 configured to receive the original set of bits from the processor 202 and map it to a trained (or corrected) constellation diagram 408 (i.e., the one obtained in the step S308 of the method 300), thereby generating the vector of data symbols. The encoder 402 further comprises a DFT precoding block 410 configured to apply DFT precoding to the vector of data symbols, thereby obtaining the following frequency-domain samples:

$$X [ k ] = \frac{1}{\sqrt{{N}_{DFT}}} {\sum }_{l = 0}^{{N}_{DFT} - 1} d [ l ] {e}^{\frac{- j 2 π kl}{{N}_{DFT}}} ,$$

where k represents the frequency-domain subcarrier index with

$$k ∈ \{ \frac{- N}{2} , \frac{N}{2} - 1 \} , d [ l ]$$

is the data symbol with the index l∈{0, 1, . . . , N_{DFT}−1}. For simplicity, a Transmission Time Interval (TTI) index is neglected, and the whole signal model is given for a single data symbol. Note that the TTI term is used herein to express the time unit that contains multiple data and pilot symbols, similar to the 5G NR definition, but the proposed method is not limited to the 5G NR structure, and it is compatible with other possible TTI structures.

The encoder 402 further comprises a PAPR reduction block 412 configured to apply a PAPR reduction mechanism to the vector of data symbols. As noted earlier, the PAPR reduction mechanism may be also trained or corrected jointly with the constellation diagram and the detection algorithm during the step S308 of the method 300. Thus, the PAPR reduction block 412 may receive a trained PAPR reduction mechanism 414 (i.e., trained peak-cancellation signals) from the processor 202. As for the peak detection, it can be based on the model described in the following scientific paper: S. Gökceli, I. Peruga, E. Tiirola, K. Pajukoski, T. Riihonen and M. Valkama, “Novel Tone Reservation Method for DFT-s-OFDM,” in IEEE Wireless Communications Letters, vol. 10, no. 10, pp. 2130-2134 October 2021. For example, a peak-cancellation signal for the i-th peak and k-th subcarrier may be configured as

$${Z}_{i} [ k ] = {A}_{i} {e}^{- {\sum }_{k} {θ}_{{κ}_{p} [ i ]} [ k ] - \frac{j 2 π kn}{N}} ,$$

where Aᵢ denotes the amplitude level determined based on the number of peaks P and the EVM limit that represents a tolerable degradation level caused by a clipping noise. To be more precise, the term Σₖ θ_{κ}_{ₚ}_{[i]}[k] is equal to the phase value of the corresponding time-domain peak, i.e., Σₖ θ_{κ}_{ₚ}_{[i]}[k]=∠(x[κₚ[i]). In an Inverse Fast Fourier Transform (IFFT) operation (which is an algorithm that realizes the IDFT shown in FIG. 4 in a fast and efficient manner), since the phase value of an associated IFFT coefficient is equal to

$$\frac{j 2 π kn}{N} ,$$

the term

$$- \frac{j 2 π kn}{N}$$

in the above equation is cancelled because of the multiplication. This way, all N_{act} terms (where N_{act} is the total number of active subcarriers) have the same phase value at the end of the element-wise multiplication. For the i-th peak, the n-th (n=κₚ[i]) time-domain sample of the clipping noise is obtained as

$${z}_{i} [ n ] = \frac{1}{\sqrt{N}} {\sum }_{k = - {N}_{act} / 2}^{{N}_{act} / 2 - 1} {A}_{i} {e}^{- {\sum }_{k} {θ}_{{κ}_{p} [ i ]} [ k ]} .$$

As seen, the phase value is configured in a way to generate the negative peak at the IFFT output. Then, the configured clipping noise is added to the original data subcarriers and a PAPR-reduced signal is obtained as

$$\overline{x} [ n ] = \frac{1}{\sqrt{N}} {\sum }_{k = - {N}_{act} / 2}^{{N}_{act} / 2 - 1} ( X [ k ] + {\sum }_{i ∈ {κ}_{p}} {Z}_{i} [ k ] ) {e}^{\frac{j 2 π kn}{N}} .$$

The encoder 402 further comprises an Inverse DFT (IDFT) block 416 configured, after zero padding, to convert the PAPR-reduced signal to the time domain through IDFT as

$$x [ n ] = \frac{1}{\sqrt{N}} {\sum }_{k = - N / 2}^{N / 2 - 1} X [ k ] {e}^{\frac{j 2 π kn}{N}} ,$$

where n∈{0, 1, . . . , N−1} denotes the time-domain sample index.

The encoder 402 further comprises a Cyclic Prefix addition block 418 configured to add a CP to the signal from the IDFT block 418. With the IDFT and CP operations, a DFT-s-OFDM waveform is obtained, which is then subjected to a random PA model by using a PA 420. The DFT-s-OFDM signal is then provided from the encoder 402 to the decoder 404 by using a channel transmission (e.g., a sub-THz channel), and the received signal at the decoder 404 can be given in the frequency domain as

$$Y [ k ] = X [ k ] H [ k ] + V [ k ] ,$$

where Y[k], H[k], and V[k] are the receiver's (RX) frequency-domain sample, frequency-domain channel and the channel noise sample at the subcarrier k, respectively.

As shown in FIG. 4, the decoder 404 comprises a CP removal block 422 configured to remove the CP from the received signal, a FFT block 424 configured to apply an FFT operation to the CP-removed signal, and a ML-based receiver 426 configured to obtain the restored set of bits from the frequency-domain symbols resulted from the FFT operation. The ML-based receiver 426 may be implemented as the so-called DeepRX receiver which is configured to generate Log Likelihood Ratios (LLRs) from the frequency-domain symbols. The detailed description of the DeepRX receiver design can be found, for example, in the following scientific paper: M. Honkala, D. Korpi and J. M. J. Huttunen, “DeepRx: Fully Convolutional Deep Learning Receiver,” in IEEE Transactions on Wireless Communications, vol. 20, no. 6, pp. 3925-3940 June 2021, doi: 10.1109/TWC.2021.3054520. Generally, to restore the bits from the frequency-domain symbols, a channel H[k] needs to be first estimated. Denoting this estimate as Hₑₛₜ[k], the estimates of the frequency-domain symbols are given by

$${Y}^{′} [ k ] = Y [ k ] {H}_{est} [ k ] .$$

It should be noted that some of the blocks shown in FIG. 4 may be omitted. For example, the PAPR reduction block 412 of the encoder 402 is optional. Furthermore, if it is required to obtain a waveform other than the DFT-s-OFDM waveform, some of the blocks of the encoder 402 and the decoder 404 may be replaced with other blocks or omitted at all (depending on the type of the waveform of interest). Thus, the present disclosure is not limited to the autoencoder design shown in FIG. 4.

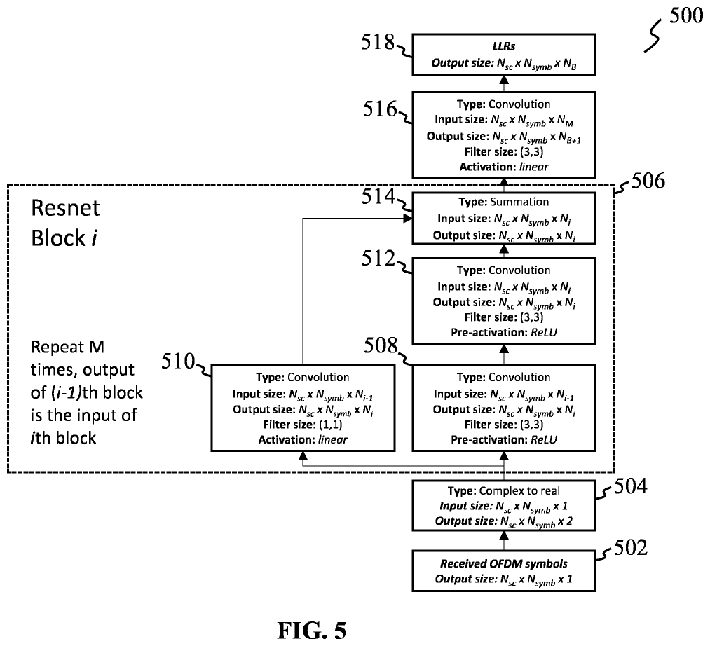

FIG. 5 shows a neural network-based architecture 500 that may be used for the autoencoder 400 in accordance with one example embodiment. More specifically, the neural network-based architecture 500 is intended to be used in the ML-based receiver 426 of the decoder 404. As shown in FIG. 5, the neural network-based architecture 500 comprises the following layers. An input layer 502 is configured to receive the frequency-domain OFDM symbols (obtained by the FFT block 424) and provide them to a complex-to-real conversion layer 504, where N_{sc} is the number of subcarriers, and N_{symb} is the number of symbols in each subcarrier. After the complex-to-real conversion, the frequency-domain OFDM symbols are fed to one or more Residual Network (ResNet) Convolutional Neural Network (CNN)-based layers 506, for each of which the input is one time transmission interval (TTI), which typically consists of 14 OFDM symbols (denoted as N_{symb}). Altogether, the ML-based receiver 426 is provided with a real-valued N_{sc}×N_{symb}×2 array, where the last dimension (i.e., “2”) represents the number of input channels, consisting of the received signal. Note that in the case of Multiple-Input and Multiple-Output (MIMO) systems, the received OFDM symbol array would consist of N_{R} samples per resource element, where N_{R} is the number of receive antennas. This array is processed with one or more ResNet CNN-based layers 506. Note that if the number of channels between two consecutive ResNet CNN-based layers 506 is the same, the convolutional layer of a skip connection can be omitted. FIG. 5 shows one exemplary implementation of the ResNet CNN-based layer 506, in which three convolution sub-layers 508-512 and one summation sub-layer 514 are used, with indication of all their main parameters known to those skilled in the art.

The output of the ResNet CNN-based layer(s) 506 is fed to a final 2-dimensional convolutional layer 516, at the output of which final log-likelihood ratio (LLR) estimates are obtained. The LLR estimates are then outputted by an output layer 518. It is possible to output 8 LLRs per resource element (RE) to support modulation orders up to 256-QAM, for example. If a lower modulation order is used, the unused LLR outputs are simply discarded.

Referring back to the step S308 of the method 300, the training of the autoencoder (e.g., the one shown in FIG. 4) may be performed as follows. By using the learned or corrected constellation diagram, the vector of data symbols is generated for each of a quite high number of TTIs. In each iteration of the training, the end-to-end transmission from the encoder to the decoder (e.g., from the encoder 402 to the decoder 404) is realized, and necessary outputs are obtained. Next, the value of the loss function is computed by using these outputs. For example, the loss function may comprise the sum of the above-mentioned three loss terms. The first term corresponding to the binary cross-entropy between the original (b[i]) and restored (\hat{b}[i]) bits may be represented as

$${ℒ}_{BCE} ( θ ) = - {\sum }_{i} b [ i ] log ( \hat{b} [ i ] ) + ( 1 - b [ i ] ) log ( 1 - \hat{b} [ i ] ) .$$

The second term corresponds to the ACLR level obtained upon applying the PA model (i.e., at the PA output). The average power of adjacent bands is computed, which is in line with the ACLR since the power of data subcarriers is normalized to 1 at the PA output and considering only out-of-band emissions is enough for quantifying the ACLR. The second term may be expressed as

$${ℒ}_{E} ( θ ) = \frac{1}{card ( {κ}_{emis} )} {\sum }_{k ∈ {κ}_{emis}} {\vert X [ k ] \vert}^{2} ,$$

where card( . . . ) denotes the cardinality (i.e., the number of elements in a given set), and κₑₘᵢₛ is the subcarrier set that contains out-of-band (OOB) subcarrier indices.

The third term is utilized to ensure that the minimum distance between the learned constellation points is maximized as much as possible so that better error performance can be obtained. For example, the third term may be denoted for 256-QAM as

$${ℒ}_{dist} ( θ ) = {min}_{i , j ∈ [ 0 , 255 ] , i \neq j} \{ \vert {c}_{ML} [ i ] - {c}_{ML} [ j ] \vert \} ,$$

where c_{ML}[i] and c_{ML}[j] are the complex-valued points of the learned constellation diagram. In the end, the final loss function is composed by considering all TTIs (batches) as

$$ℒ ( θ ) = {\sum }_{q = 1}^{Q} {log}_{2} ( 1 + {snr}_{q} ) {ℒ}_{BCE , q} ( θ ) + {W}_{E} log ( {\sum }_{q = 1}^{Q} {ℒ}_{E , q} ( θ ) ) + {W}_{dist} log ( {\sum }_{q = 1}^{Q} {ℒ}_{dist , q} ( θ ) ) ,$$

where the batch index q is also used to show how the value of the composed loss function is computed. Accordingly, the terms [symbol] _{BCE}(θ), [symbol] _{E}(θ) and [symbol] _{dist}(θ) are computed for each batch's bits and signals, then these are separately summed over all batches. Moreover, W_{E} and W_{dist} denote the weights for the terms [symbol] _{E}(θ) and [symbol] _{dist}(θ), respectively. The training condition (checked in the step S310 of the method 300) is realized by computing the gradient of the loss function [symbol] (θ) in accordance with the trainable parameters θ, which are then updated using the ADAM optimizer or any other SGD method. This way, the learned model is generated at the end of the training.

### Numerical Evaluations

The training of the autoencoder 400 (i.e., the constellation diagram 408 of the encoder 402 and the detection algorithm of the DeepRX receiver 426 of the decoder 404) was conducted by considering 150000 iterations with the batch size of 40. Moreover, a Signal-to-Noise Ratio (SNR) range of from 10 dB to 25 dB was considered and 216 data subcarriers were utilized with the subcarrier spacing of 120 kHz. Also, the number of guard-band subcarriers was configured as 108 and the CP length of 35 was set.

An extensive validation was conducted to evaluate the training performance of the autoencoder 400 by generating completely random data with 100 batches and 10 different SNR points.

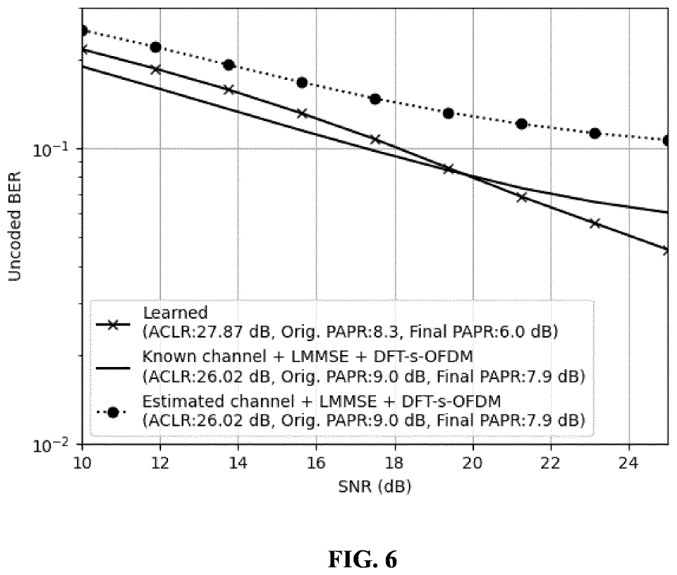

FIG. 6 shows uncoded Bit-Error Rate (BER) results obtained by using the method 300 (with the autoencoder 400) and two baseline methods without ML-based constellation shaping. In each of the two baseline methods, conventional DFT-s-OFDM waveforms were used, and the DFT precoding, PAPR reduction and IDFT operations were performed in the same manner as discussed above. For the first baseline method, perfect channel knowledge was assumed. Thus,

$${H}_{est} [ k ] = \frac{1}{H [ k ]} ,$$

and the above-given equation for Y′[k] can be written as

$${Y}^{′} [ k ] = \frac{Y [ k ]}{H [ k ]} .$$

For the second baseline method, Hₑₛₜ[k] was obtained through Linear Minimum Mean Square Error (LMMSE) estimation. Here, transmitted pilot symbols are used for channel estimation corresponding to the pilots' locations across subcarriers. Next, interpolation was performed to estimate the channel corresponding to the transmitted DFT-s-OFDM symbols, and it can be given as

$${H}_{est} [ k ] = \frac{{H}_{int} [ k ]}{{\vert {H}_{int} [ k ] \vert}^{2} + {σ}^{2}} ,$$

where Hᵢₙₜ[k] is the interpolated channel and it can be given as estimate, σ² is the estimated noise variance, and |·|² denotes the absolute-squared operation. Thus, the above-given equation for Y′[k] can be rewritten for the second baseline method as

$${Y}^{′} [ k ] = \frac{Y [ k ] {H}_{int} [ k ]}{{\vert {H}_{int} [ k ] \vert}^{2} + {σ}^{2}} .$$

Once the received frequency-domain symbols were estimated, a demapping operation was applied on them to calculate LLRs.

As can be seen from FIG. 6, the method 300 leads to exceptionally good BER performance, quite close to that obtained by the perfect baseline method with the known channel. Moreover, it can even outperform this case at the high SNR range where the SNR value is higher than 20 dB. At the first glance, this might look strange, but the baseline method suffers from high PA nonlinearity while the DeepRx receiver 426 of the autoencoder 400 can cope with that quite well, which brings this performance gain over the baseline method.

Moreover, as also shown in FIG. 6, the method 300 results in a reasonable increase in the ACLR while providing superior BER performance, where the ACLR gain with respect to baselines is around 1.9 dB. One key reason for this ACLR gain is that a more aggressive PAPR reduction was applied in the method 300 compared to the baseline methods. Note that the PAPR parameters that bring the minimum BER and maximum ACLR level were tuned for all cases. The aggressive PAPR reduction has one crucial drawback, the clipping noise signal's power is increased, and this significantly degrades the EVM and the BER. The key benefit of the method 300 is that the DeepRx receiver 426 of the autoencoder 400 can significantly tolerate a higher clipping noise power. This way, the PAPR can be decreased around 2.3 dB in the method 300 with respect to its original value. In the baseline methods, this level is limited to around 1 dB.

Conventionally, the EVM loss caused by the PAPR reduction cannot be improved due to the random nature of the clipping noise. On the other hand, the unique relation between time domain peaks and QAM symbols in the DFT-s-OFDM case, and the robustness of the DeepRx receiver 426 make it possible to tolerate a more severe clipping noise and, consequently, more aggressive PAPR reduction. Furthermore, as also shown in FIG. 6, the learned constellation diagram already brings close to 1 dB improvement in the PAPR with respect to baselines, which will be discussed below. A good balance between the BER and ACLR metrics is obtained thanks also to this added benefit of the learned constellation diagram.

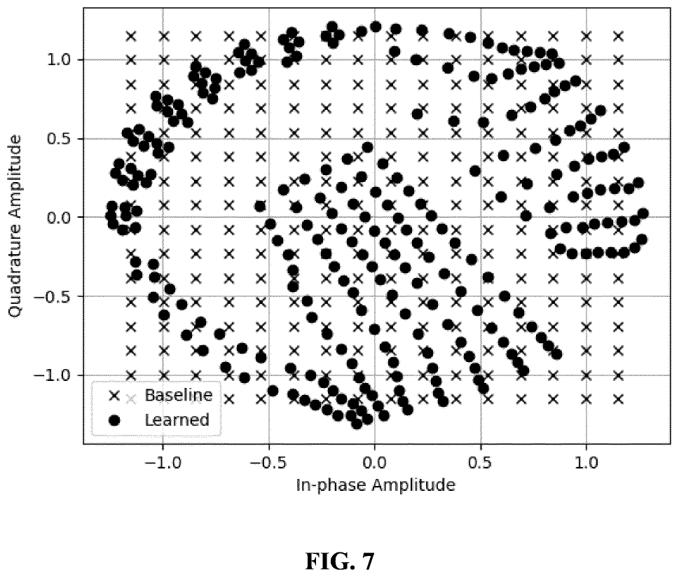

FIG. 7 shows a learned constellation diagram versus a regular 256-QAM constellation diagram. As can be seem from FIG. 7, the learned constellation diagram (which is shown by using black circles) obtained by the method 300 (with the aid of the autoencoder 400) is quite different from the original 256-QAM constellation diagram (which is shown by using crisscrosses), and the PAPR of the DFT-s-OFDM waveform is reduced already with this learned constellation diagram. As described earlier, unlike in the CP-OFDM case, the PAPR problem of the DFT-s-OFDM waveform is caused mainly by the anti-phase outer constellation points. However, it is not trivial to alternate the constellation points in a way to prevent peaks as the modification of the outer constellation points leads to bit errors. Hence, a constellation shaping approach is a very reasonable one to solve this problem, and as shown with the results, it optimizes the constellation diagram quite well, so that both good BER and PAPR metrics are obtained. As also follows from FIG. 7, the outer constellation points are replaced with alternative ones, resulting in 1 dB improvement in the PAPR, which is shown in FIG. 6. Moreover, the learned constellation diagram is asymmetrical, which is exploited by the DeepRx receiver 426 of the autoencoder 400 to correct degradations in both amplitude and phase.

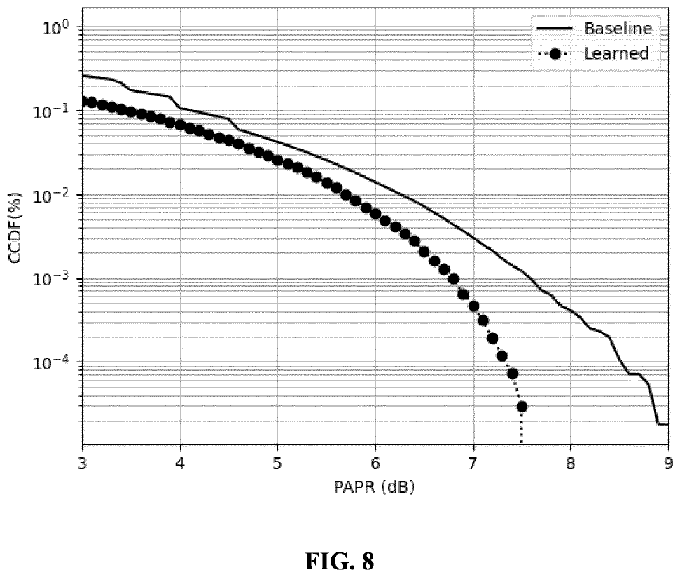

FIG. 8 shows PAPR results obtained for a DFT-s-OFDM waveform by using the original 256-QAM constellation diagram and the learned constellation diagram. It should be noted that, in this case, the additional PAPR reduction mechanism described earlier was not included, so these results correspond to the original PAPR values (“Orig. PAPR” in the legends) in FIG. 6. More specifically, FIG. 8 shows the PAPR results obtained with respect to Complementary Cumulative Distribution Function (CCDF) levels. As can be seen, the learned constellation diagram has a clear PAPR advantage over the original 256-QAM constellation, where the PAPR gains are observed at all CCDF probability levels. Especially at the CCDF level of 10⁻⁴, a difference around 1 dB is observed.

It should be noted that the learned constellation diagram has the handicap of reduced Euclidean distance between constellation points, and this would likely lead to increase in the BER. Therefore, a similar modification to the original 256-QAM modulation may not be feasible due to this BER disadvantage. On the other hand, as observed from FIG. 6, the DeepRx receiver 426 of the autoencoder 400 can exploit the learned constellation diagram in a way to cope with such constellation structure when jointly trained with the constellation diagram.

Hence, the joint correction of the constellation diagram and the detection algorithm used by the DeepRX receiver 426 during the training of the autoencoder 400 brings a well optimized end-to-end model that provides better BER performance over the baseline methods, while also satisfying higher energy efficiency.

It should be noted that each step or operation of the method 300, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 202. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An apparatus for performing Machine Learning (ML)-based constellation shaping in a wireless communication network, comprising:
at least one processor; and
at least one memory storing instructions that, when executed by the at least one processor, cause the at least one processor at least to:
(a) obtain an original set of bits;
(b) process the original set of bits by using an autoencoder comprising an encoder and a decoder, wherein the encoder is configured to encode the original set of bits into a vector of data symbols by mapping the original set of bits to a constellation diagram corresponding to a modulation scheme of interest and transmit the vector of data symbols to the decoder while applying a random Power Amplifier (PA) model to the vector of data symbols, and wherein the decoder is configured to receive the vector of data symbols and obtain a restored set of bits by decoding the received vector of data symbols in accordance with a detection algorithm;
(c) calculate a value of a loss function based on the original set of bits and the restored set of bits;
(e) train the autoencoder by jointly correcting the constellation diagram and the detection algorithm based on the value of the loss function;
(f) repeat operations (b)-(e) by using the corrected constellation diagram and the corrected detection algorithm until a target training condition is met.

2. The apparatus of claim 1, wherein the encoder of the autoencoder is configured to transmit the vector of data symbol by using an Orthogonal Frequency Division Multiplex (OFDM) waveform.

3. The apparatus of claim 2, wherein the OFDM waveform comprises a Discrete Fourier Transform spread OFDM (DFT-s-OFDM) waveform or a Cyclic Prefix OFDM (CP-OFDM) waveform.

4. The apparatus of claim 1, wherein the encoder of the autoencoder is further configured, before transmitting the vector of data symbols, to apply a Peak-to-Average Power Ratio (PAPR) reduction mechanism to the vector of data symbols in a frequency domain.

5. The apparatus of claim 4, wherein the at least one processor is caused, in operation (e), to train the autoencoder by jointly correcting the constellation diagram, the detection algorithm and the PAPR reduction mechanism based on the value of the loss function.

6. The apparatus of claim 1, wherein the loss function comprises a sum of:
a first term associated with a binary cross-entropy between the original set of bits and the restored set of bits;
a second term associated with an Adjacent Channel Leakage Ratio (ACLR) after the PA model is applied to the vector of data symbols; and
a third term associated with a minimum distance between points of the constellation diagram.

7. The apparatus of claim 1, wherein the target training condition is based on a Stochastic Gradient Descent (SGD) algorithm.

8. A method for performing Machine Learning (ML)-based constellation shaping in a wireless communication network, comprising:
(a) obtaining an original set of bits;
(b) processing the original set of bits by using an autoencoder comprising an encoder and a decoder, wherein the encoder is configured to encode the original set of bits into a vector of data symbols by mapping the original set of bits to a constellation diagram corresponding to a modulation scheme of interest and transmit the vector of data symbols to the decoder while applying a random Power Amplifier (PA) model to the vector of data symbols, and wherein the decoder is configured to receive the vector of data symbols and obtain a restored set of bits by decoding the received vector of data symbols in accordance with a detection algorithm;
(c) calculating a value of a loss function based on the original set of bits and the restored set of bits;
(e) training the autoencoder by jointly correcting the constellation diagram and the detection algorithm based on the value of the loss function; and
(f) repeating steps (b)-(e) by using the corrected constellation diagram and the corrected detection algorithm until a target training condition is met.

9. The method of claim 8, wherein the encoder of the autoencoder is configured to transmit the vector of data symbol by using an Orthogonal Frequency Division Multiplex (OFDM) waveform.

10. The method of claim 9, wherein the OFDM waveform comprises a Discrete Fourier Transform spread OFDM (DFT-s-OFDM) waveform or a Cyclic Prefix OFDM (CP-OFDM) waveform.

11. The method of claim 8, wherein the encoder of the autoencoder is further configured, before transmitting the vector of data symbols, to apply a Peak-to-Average Power Ratio (PAPR) reduction mechanism to the vector of data symbols.

12. The method of claim 11, wherein the PAPR reduction mechanism is corrected, in step (e), jointly with the constellation diagram and the detection algorithm based on the value of the loss function.

13. The method of claim 8, wherein
the loss function comprises a sum of:
a first term associated with a binary cross-entropy between the original set of bits and the restored set of bits;
a second term associated with an Adjacent Channel Leakage Ratio (ACLR) after the PA model is applied to the vector of data symbols; and
a third term associated with a minimum distance between points of the constellation diagram.

14. The method of claim 8, wherein the target training condition is based on a Stochastic Gradient Descent (SGD) algorithm.

15. A computer program product comprising a non-transitory computer-readable storage medium, wherein the computer-readable storage medium stores a computer code which, when executed by at least one processor, causes the at least one processor to:
(a) obtain an original set of bits;
(b) process the original set of bits by using an autoencoder comprising an encoder and a decoder, wherein the encoder is configured to encode the original set of bits into a vector of data symbols by mapping the original set of bits to a constellation diagram corresponding to a modulation scheme of interest and transmit the vector of data symbols to the decoder while applying a random Power Amplifier (PA) model to the vector of data symbols, and wherein the decoder is configured to receive the vector of data symbols and obtain a restored set of bits by decoding the received vector of data symbols in accordance with a detection algorithm;
(c) calculate a value of a loss function based on the original set of bits and the restored set of bits;
(e) train the autoencoder by jointly correcting the constellation diagram and the detection algorithm based on the value of the loss function; and
(f) repeat steps (b)-(e) by using the corrected constellation diagram and the corrected detection algorithm until a target training condition is met.
